(19) United States
(12) Patent Application Publication
(10) Pub. No.: US 2024/0326137 A1
(43) Pub. Date: Oct. 3, 2024

(54) DEBURRING DEVICE

(71) Applicant: HONDA MOTOR CO., LTD., Tokyo (JP)

(72) Inventors: Takashi YOSHIDA, Tokyo (JP); Shimpei MATSUMOTO, Tokyo (JP); Megumi TAWARA, Tokyo (JP)

(21) Appl. No.: 18/585,074

(22) Filed: Feb. 23, 2024

(30) Foreign Application Priority Data
Mar. 29, 2023 (CN) 202310320193.8

(51) Int. Cl. B23C 3/12; B23C 9/00

(52) U.S. Cl. CPC B23C 3/12; B23C 9/00

(57) ABSTRACT

The present invention provides a deburring device capable of removing a burr with high precision. A deburring device 1 for removing a burr formed on a joint of metal members joined together by friction stir welding (FSW) includes: a deburrer including a cutting blade that cuts the burr formed on the joint, a drive mechanism that drives the cutting blade to rotate, and a guide roller that has a diameter equal to or smaller than the cutting blade, is able to rotate coaxially with the cutting blade, and makes contact with a surface of the joined metal members at the joint to control the amount of cutting by the cutting blade; a mover that moves the deburrer along the joint; and an orientation controller that controls an orientation of the deburrer according to the shape of the surface of the joined metal members.

This application is based on and claims the benefit of priority from Chinese Patent application No. CN202310320193.8 filed on Mar. 29, 2023, the content of which is incorporated herein by reference.

### BACKGROUND OF THE INVENTION

### Field of the Invention

The present disclosure relates to a deburring device.

### Related Art

A deburring machine has been known as a device for removing a projection called a burr generated as a result of cutting or joining of metal members. For example, a tool has been known, in which a cutting blade for removing the burr is attached to a rotation shaft, and a stopper that can adjust the cutting depth is provided circumferentially outside the rotation of the cutting blade (see, for example, Patent Document 1). With this tool, the chamfering of a machined hole formed in a target object can be controlled without exceeding a predetermined depth.
Patent Document 1: Japanese Unexamined Utility Model Application, Publication No. S61-105513

### SUMMARY OF THE INVENTION

When metal members are joined together by friction stir welding (FSW), burrs are left on both ends in a width direction of a welded joint. If the tool of Patent Document 1 is used in this case, the stopper interferes with the burrs. Thus, the tool needs to be held with the stopper raised up off the burrs, making the removal of the burrs with high precision difficult.

The present invention provides a deburring device that can achieve high-precision removal of a burr that is generated in joining metal members together by friction stir welding (FSW).

In an aspect (1) of the present invention, a deburring device (e.g., a deburring device 1) for removing a burr (e.g. a burr 91) formed on a joint (e.g., a joint 9) of metal members (e.g., metal members 90) joined together by friction stir welding includes: a deburrer (e.g., a deburrer 10) including a cutting blade (e.g., a cutting blade 21) that cuts the burr formed on the joint, a drive mechanism (e.g., a drive mechanism 3) that drives the cutting blade to rotate, and a guide roller (e.g., a guide roller 4) that has a diameter equal to or smaller than the cutting blade, is able to rotate coaxially with the cutting blade, and makes contact with a surface of the joined metal members at the joint to control the amount of cutting by the cutting blade; a mover (e.g., a mover 70) that moves the deburrer along the joint; and an orientation controller (e.g., an orientation controller 80) that controls an orientation of the deburrer according to a shape of the surface of the joined metal members.

(2) In the deburring device of the aspect (1), the orientation controller preferably includes a force sensor (e.g., a force sensor 81) capable of detecting a positional change of the deburrer and a control unit (e.g., a control unit 82) that controls the orientation of the deburrer according to the detection result of the force sensor.

(3) In the deburring device of the aspect (2), it is preferable that the force sensor is arranged on a connector (e.g., a connector 65) between the deburrer and the mover and detects the positional change of the deburrer depending on the shape of the surface of the joined metal members at the joint, and the control unit controls a holding position in which the mover holds the deburrer to be on the same axis as a rotation shaft (e.g., a rotation shaft 32) of the deburrer according to the detection result of the force sensor.

(4) In the deburring device of the aspect (2), it is preferable that the force sensor is arranged on the guide roller and detects a positional change of the guide roller depending on the shape of the surface of the joined metal members at the joint, and the control unit controls a holding position in which the mover holds the deburrer to be on the same axis as a rotation shaft of the deburrer according to the detection result of the force sensor.

(5) In the deburring device of the aspect (1) or (2), it is preferable that the deburring device further includes a housing (e.g., a housing 5) that houses the deburrer, and the housing has an opening (e.g., an opening 52) formed at a bottom side to expose the guide roller and the cutting blade and a chip suction mechanism (e.g., a chip suction mechanism 53) that sucks air from inside the housing to suck chips of the cut burr.

(6) In the deburring device of the aspect (1), the orientation controller preferably includes a spring member that is arranged between the deburrer and the mover.

(7) In the deburring device of the aspect (6), it is preferable that the deburring device further includes a housing that houses the deburrer, and the housing has an opening at a bottom side to expose the guide roller and the cutting blade and a chip suction mechanism that sucks air from inside the housing to suck chips of the cut burr.

In the aspect (1), the guide roller having the diameter equal to or smaller than the cutting blade rotates together with the cutting blade and moves along the surface of the joined metal members at the joint. While the guide roller moves, the cutting blade cuts the burr. This can avoid the burr from remaining uncut and can avoid excessive cutting that may leave scratches on the joined metal members. The guide roller of the deburrer moves along the surface of the joined metal members, and the orientation of the deburrer is controlled according to the shape of the surface of the joined metal members. Thus, although the surface of the metal members is curved or uneven, the burr can be removed with the amount of cutting appropriately controlled irrespective of the surface shape of the joined metal members.

In the aspect (2), the position control can be achieved more accurately.

In the aspect (3), the deburring device can be downsized, and a visual check of the positional change of the deburrer is performed easily.

In the aspect (4), the force sensor attached to the guide roller allows more accurate and finer detection of the orientation of the deburrer, allowing more accurate orientation control.

In the aspect (5), the influence of the chips on the orientation control of the deburrer and the cutting process can be reduced, improving deburring accuracy.

In the aspect (6), the deburring device with a simple structure can follow the shape of the surface of the metal member at the joint without using the force sensor.

In the aspect (7), the influence of the chips on the orientation control of the deburrer and the cutting process can be reduced, improving deburring accuracy.

### BRIEF DESCRIPTION OF THE DRAWINGS

FIG. 1 is a side view of a deburring device of a first embodiment;

FIG. 2 is a front view of the deburring device of the first embodiment;

FIG. 3 is a view of the deburring device of the first embodiment in use;

FIG. 4 is a side view of a deburring device of a second embodiment;

FIG. 5 is a side view of a deburring device of a third embodiment;

FIG. 6 is a front view of the deburring device of the third embodiment; and

FIG. 7 is a side view of a deburring device of a fourth embodiment.

### DETAILED DESCRIPTION OF THE INVENTION

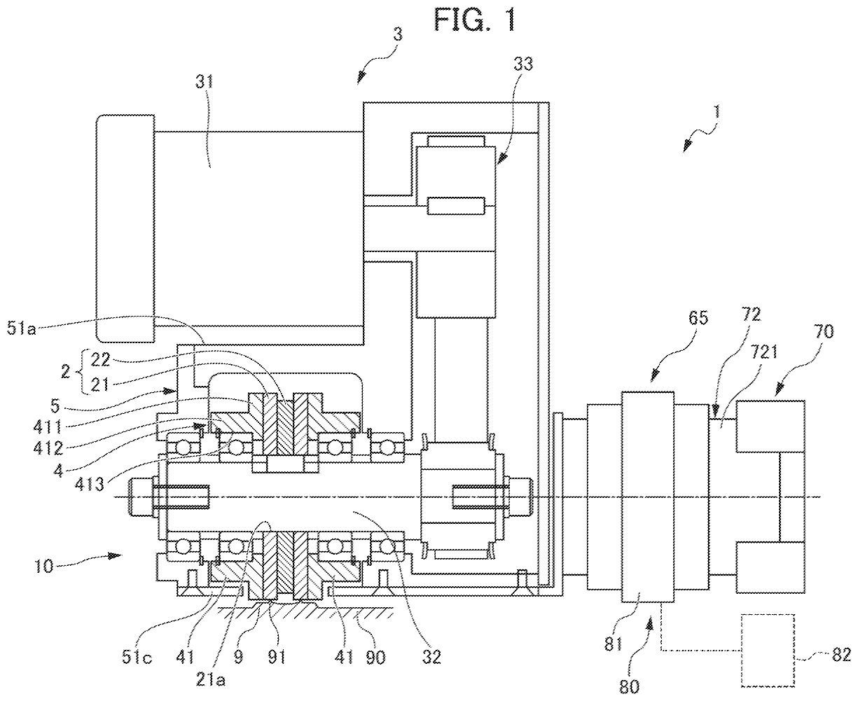

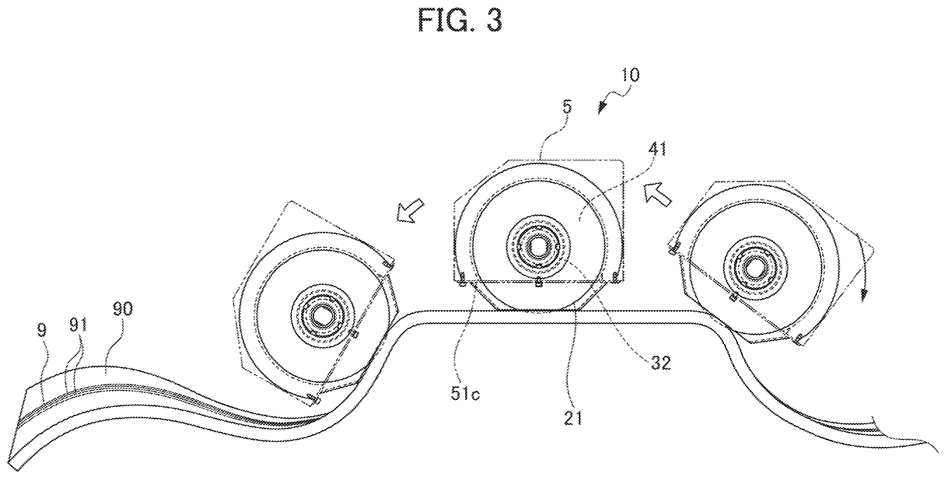

A first embodiment of the present invention will be described below with reference to the drawings. As shown in FIG. 1, a deburring device 1 of the first embodiment is a device that removes burrs 91 formed and left on a joint 9 of metal members 90 as a base material joined together by friction stir welding (FSW). As shown in FIG. 3, for example, the joint 9 is formed with a predetermined joint width at a boundary between one of the metal members 90 and the other metal member 90 joined together. Specifically, the friction stir welding is employed to join two metal members at their surfaces butted against each other and join two metal members at an overlapping part. The deburring device of the present embodiment can remove the burrs in both cases. The joint 9 may protrude slightly more than the other part of the metal members 90. The burrs 91 are generated on both sides of the joint 9 in the width direction. The burrs 91 protrude upward from the surface of the joined metal members 90 at the joint 9. As an example, the joint width is about 20 mm, and the burrs have a height of about 0.5 mm, but the width and the length are not limited to these values.

The deburring device 1 includes a deburrer 10, a mover 70, a connector 65, and an orientation controller 80. The deburrer 10 is a part that rotates on the surface of the joint 9 to remove the burrs 91, and includes a cutter 2, a drive mechanism 3, a guide roller 4, and a housing 5.

In this specification, a front view means a view from a direction substantially orthogonal to the moving direction of the deburring device 1, i.e., from a direction opposite to the mover 70 which will be described later. A side view means a view from a side seeing the deburring device 1 moving. In the side view, the side on which the mover 70 is arranged will be referred to as the rear side, and the other side with no mover 70 will be referred to as the front side.

The cutter 2 is a metal saw that cuts the burrs. The cutter 2 includes a cutting blade 21 and a spacer 22. The cutting blade 21 is substantially circular when viewed from the front and has teeth on the whole outer periphery. A through hole 21a is formed at the center of the cutting blade 21 so that a rotation shaft 32 which will be described later can be inserted in it. Two cutting blades 21 having the same shape are arranged to face each other with the spacer 22 sandwiched between the cutting blades 21. The spacer 22 is substantially circular when viewed from the front and is arranged to be able to rotate coaxially with the cutting blades 21. The spacer 22 has a smaller diameter than the cutting blades 21.

The drive mechanism 3 includes a motor 31 and a drive transmission mechanism 33 and drives the cutting blades 21 and the guide roller 4 which will be described later to rotate. The motor 31 is an air motor that rotates the rotation shaft 32 using compressed air as power. The motor 31 is not limited to the air motor, and any other motors such as an induction motor may be used. The drive transmission mechanism 33 is coupled to the rotation shaft 32 and drives the rotation shaft 32 to rotate. The rotation shaft 32 is connected to the cutter 2 and the guide roller 4 by penetrating the center of the cutter 2 and the center of the guide roller 4.

The guide roller 4 is substantially circular when viewed from the front and is arranged to be able to rotate coaxially with the cutter 2 to guide the cutter 2. The guide roller 4 has two guide members 41 of the same shape. Each of the guide members 41 has a following part 411, a shaft support 412, and a through hole 413.

The following part 411 makes contact with the surface of the joined metal members 90 at the joint 9 while rotating to restrict the amount of cutting by the cutting blades 21. Specifically, the following part 411 moves along, not the burr 91, but the surface of the metal members 90 as the base material. The following part 411 is substantially circular when viewed from the front, and has a predetermined thickness and substantially the same diameter as the cutting blades 21. The following part 411 is arranged on the surface of the cutting blade 21 opposite to the spacer 22.

The shaft support 412 is substantially cylindrical, has a smaller diameter than the following part 411, and extends along the rotation shaft 32 of the drive mechanism 3 from the following part 411. The shaft support 412 is connected to the rotation shaft 32, allowing the guide roller 4 to rotate together with the rotation of the rotation shaft 32. The through hole 413 is formed at the center of the following part 411 and the center of the shaft support 412 and allows the rotation shaft 32 to pass through it.

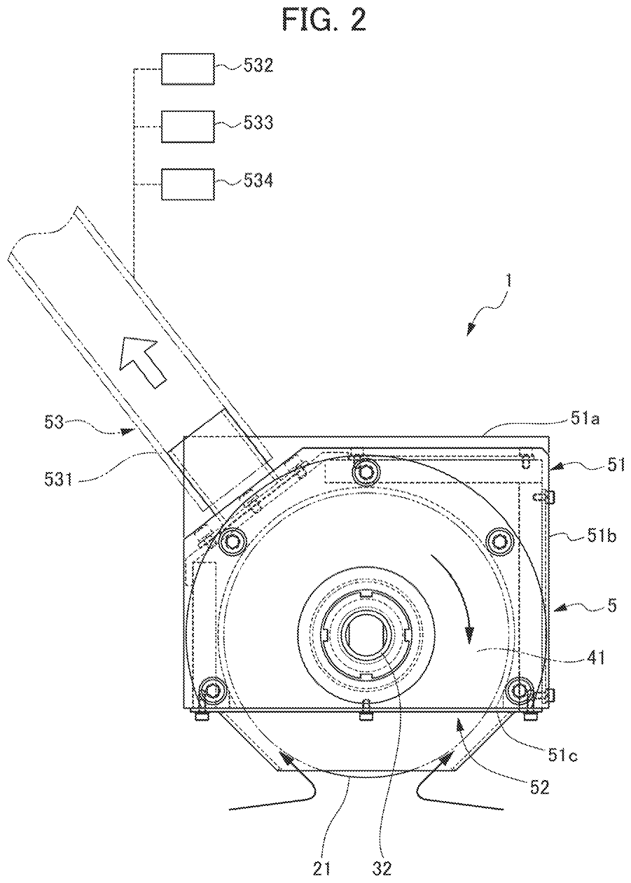

The housing 5 is a case that houses the deburrer 10 and includes a body 51, an opening 52, and a chip suction mechanism 53 as shown in FIG. 2. The body 51 has a top surface 51a, a pair of side surfaces 51b, and a bottom surface 51c surrounding the deburrer 10, and the opening 52 is formed in the bottom surface 51c to expose the guide roller 4 and the cutting blades 21. The body 51 keeps chips generated when cutting the burrs 91 with the deburrer 10 from scattering. The opening 52 is formed by opening part of the bottom surface 51c of the body 51.

The chip suction mechanism 53 sucks air from inside the housing 5 to suck the chips of the cut burrs 91. The chip suction mechanism 53 includes a suction hose 531, a dust collector 532, a pump 533, and a driver 534.

An end of the suction hose 531 is connected to the corner formed by the top surface 51a and one of the side surfaces 51b of the housing 5. The suction hose 531 extends radially from the rotation shaft 32 relative to the rotation of the cutting blades 21. This allows more efficient collection of the chips scattering from the rotating cutting blades 21. The dust collector 532 is a container connected to the other end of the suction hose 531 to collect the chips coming through the suction hose 531.

The pump 533 generates negative pressure in the housing 5 and the suction hose 531 to suck the air. The driver 534 is a motor that drives the pump 533.

When the driver 534 drives the pump 533, the chip suction mechanism 53 sucks the air from inside the housing 5 through the suction hose 531. When the air in the housing 5 is sucked, the air flows into the housing 5 from the opening 52. The air also flows easily from the spacer 22 arranged between the two cutting blades 21 into a suction port of the suction hose 531, improving the dust collection efficiency.

The connector 65 is arranged between the deburrer 10 and the mover 70 to connect the deburrer 10 and the mover 70.

The mover 70 is a device, specifically a robot, connected to the deburrer 10 to move the deburrer 10 along the surface of the joined metal members 90 at the joint 9. The mover 70 includes an arm 72 connected to the deburrer 10 via the connector 65 to hold the deburrer 10. The arm 72 is movable along the joint 9 and has a substantially cylindrical shaft 721. The shaft 721 extends along the rotation shaft 32 of the deburrer 10. More specifically, the shaft 721 is connected to the deburrer 10 so that the central axis of the shaft 721 is on the same axis as the rotation shaft 32 of the drive mechanism 3.

The orientation controller 80 controls the orientation of the deburrer 10 according to the shape of the joint 9. The orientation controller 80 includes a force sensor 81 and a control unit 82. The force sensor 81 detects the position of the deburrer 10 making contact with the joint 9 from the change of the surface shape of the metal members 90 forming the joint 9. For example, as shown in FIG. 3, when the surface of the joint 9 is curved along the shape of the product or corrugated with ups and downs, the surface of the joint 9 also changes with ups and downs in different directions depending on the shape of the metal member 90. The force sensor 81 detects a positional change of the deburrer 10, such as the positional changes of the cutting blades 21 and the guide roller 4, in response to the change of the surface shape of the joint 9. The force sensor 81 may be of any type. The sensor may be any sensor, such as a strain gauge sensor, an optical sensor, a piezoelectric sensor, and a capacitive sensor.

The control unit 82 is a central processing unit electrically connected to the deburrer 10 and the mover 70. The control unit 82 receives a signal indicating the detection result from the force sensor 81 and controls the orientation of the deburrer 10 according to the detection result. More specifically, the control unit 82 controls the position of the mover 70 holding the deburrer 10 to be on the same axis as the rotation shaft 32 of the drive mechanism 3. The mover 70 moves the deburrer 10 so that the deburrer 10 moves along the surface of the joint 9. At this time, the deburrer 10 is moved with the guide roller 4 kept in contact with the surface of the joint 9.

The first embodiment has the following advantages.

(1) The deburring device 1 for removing the burr 91 formed on the joint 9 of the metal members 90 joined together by friction stir welding (FSW) includes: the deburrer 10 including the cutting blade 21 that cuts the burr 91 formed on the joint 9, the drive mechanism 3 that drives the cutting blade 21 to rotate, and the guide roller 4 that has a diameter equal to or smaller than the cutting blade 21, is able to rotate coaxially with the cutting blade 21, and makes contact with a surface of the joined metal members 90 at the joint 9 to control the amount of cutting by the cutting blade 21; the mover 70 that moves the deburrer 10 along the joint 9; and the orientation controller 80 that controls the orientation of the deburrer 10 according to the shape of the surface of the joined metal members 90. The guide roller 4 having the diameter equal to or smaller than the cutting blade 21 rotates together with the cutting blade 21 and moves along the surface of the joined metal members 90 at the joint 9. While the guide roller 4 moves, the cutting blade 21 cuts the burr 91. This can avoid the burr 91 from remaining uncut and can avoid excessive cutting that may leave scratches on the joined metal members 90. The guide roller 4 of the deburrer 10 moves along the surface of the joined metal members 90, and the orientation of the deburrer 10 is controlled according to the shape of the surface of the joined metal members 90. Thus, although the surface of the joined metal members 90 is curved or uneven, the burr can be removed with the amount of cutting appropriately controlled irrespective of the surface shape of the joined metal members 90.

(2) In the first embodiment, the orientation controller 80 includes the force sensor 81 capable of detecting the positional change of the deburrer 10 and the control unit 82 that controls the orientation of the deburrer 10 according to the detection result of the force sensor 81. The force sensor 81 detects the positional change of the deburrer 10, and the orientation of the deburrer 10 is controlled according to the detection result, achieving more accurate position control.

(3) In the first embodiment, the force sensor 81 is arranged on the connector 65 between the deburrer 10 and the mover 70, and the positional change of the deburrer 10 is detected from the shape of the surface of the joined metal members 90 at the joint 9. The control unit 82 controls a holding position in which the mover 70 holds the deburrer 10 to be on the same axis as the rotation shaft 32 of the deburrer 10 according to the detection result of the force sensor 81. This can downsize the deburring device 1 and allows easy visual check of the positional change of the deburrer 10.

(4) In the first embodiment, the deburring device 1 further includes the housing 5 that houses the deburrer 10, and the housing 5 has an opening 52 formed at the bottom side to expose the guide roller 4 and the cutting blade 21 and the chip suction mechanism 53 that sucks the air from inside the housing 5 to suck the chips of the burr 91. The chips generated when cutting the burr 91 may adhere to the guide roller 4 and the cutting blade 21. When the chips are sucked, the influence of the chips on the orientation control of the deburrer 10 and the cutting process can be reduced, improving deburring accuracy.

The present invention is not limited to the embodiment described above, and may be modified or improved to the extent that the purpose can be achieved. In the description of the second embodiment and other embodiments, the same components as those described in the first embodiment are not described in detail. For example, deburring devices 1A to 1C of the second to fourth embodiments also include the housing 5 having the opening 52 and the chip suction mechanism 53, just like the deburring device 1 of the first embodiment.

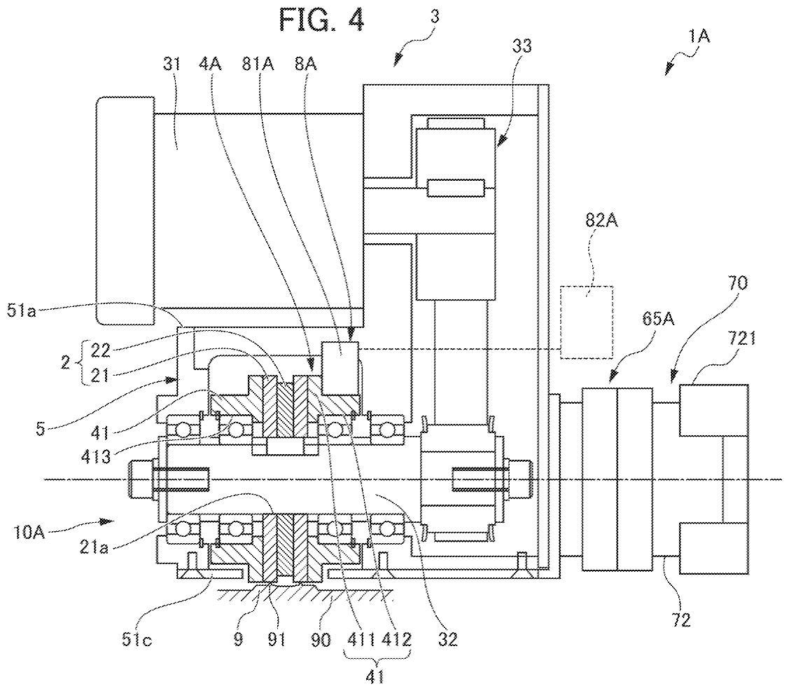

FIG. 4 is a side view of a deburring device 1A of the second embodiment. The deburring device 1A has a force sensor 81A that is not arranged on a connector 65A between a deburrer 10A and a mover 70, but is arranged directly on a guide roller 4A. The force sensor 81A detects the position of the guide roller 4A that changes depending on the shape of the surface of the joined metal members 90 at the joint 9. The control unit 82 controls the orientation of the deburrer 10A according to the detection result of the force sensor 81 attached to the guide roller 4A. The control unit 82 controls the position of the mover 70 holding the deburrer 10A to be on the same axis as the rotation shaft 32 of the deburrer 10A.

In the second embodiment, the force sensor 81A attached to the guide roller 4A allows more accurate and finer detection of the orientation of the deburrer 10A, allowing more accurate orientation control.

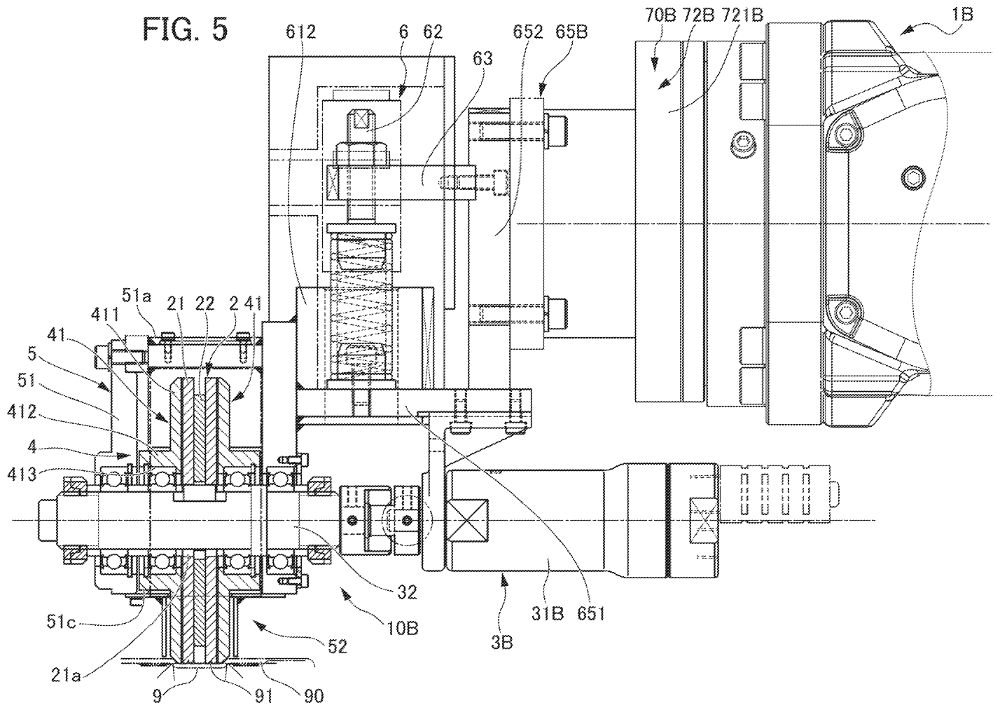

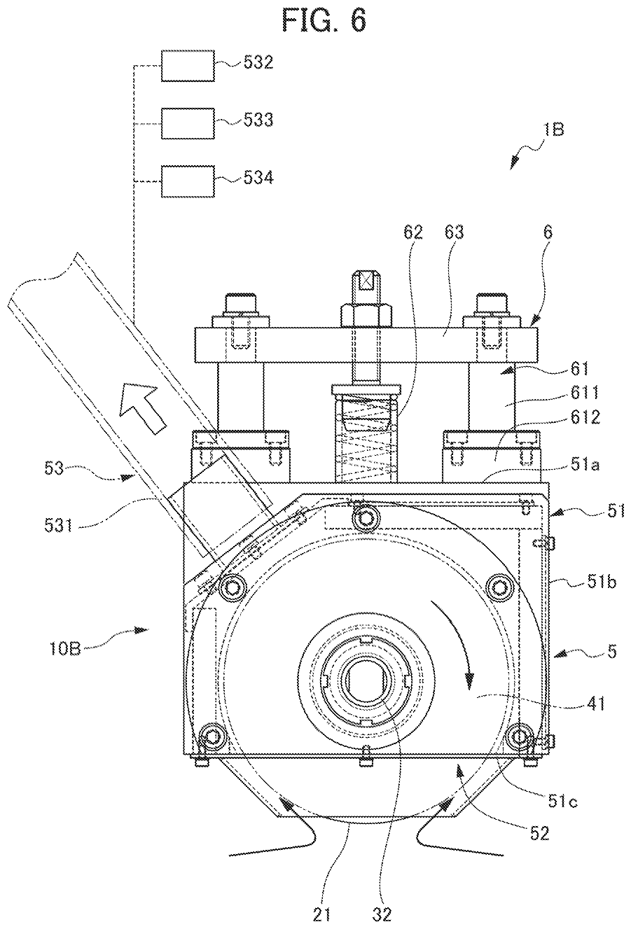

FIGS. 5 and 6 show a deburring device 1B of the third embodiment. The deburring device 1B of the third embodiment does not include the orientation controller 80 including the force sensor 81 employed in the first and second embodiments. The deburring device 1B includes a float support 6 in place of the orientation controller 80.

The float support 6 is a mechanism that is connected to an upper part of the housing 5 and supports the deburrer 10B to be movable up and down. The float support 6 supports the deburrer 10B so that a load is applied from above to the joined metal members 90 via the housing 5, and simultaneously, connects the mover 70 and the deburrer 10B so that the mover 70 follows the movement of the deburrer 10B when the deburrer 10B moves up and down along the shape of the surface of the joined metal members 90. As shown in FIG. 6, the float support 6 includes a pair of floating guides 61, a float 62, and a coupling part 63.

The pair of floating guides 61 is located behind the housing 5, and one is arranged on the right and the other is on the left when viewed from the front. The floating guides 61 include a pair of poles 611 and a movable part 612. As shown in FIG. 5, the pair of poles 611 is fixed to a support plate 651 of the connector 65B that is arranged between the deburrer 10B and the mover 70 and will be described later. The movable part 612 is connected to a rear surface of the housing 5 with the pair of poles 611 penetrating the movable part 612, and is movable up and down along the poles 611.

The float 62 is arranged between the pair of floating guides 61 and includes a spring member extending in the vertical direction. The float 62 has a lower end connected to the support plate 651.

The coupling part 63 is a plate that couples the pair of floating guides 61 and the float 62 and fixes the top of the pair of floating guides 61 and the top of the float 62. The coupling part 63 is connected to a connector plate 652 of the connector 65B.

The connector 65B is arranged between the deburrer 10B and the mover 70 and includes the support plate 651 and the connector plate 652. The support plate 651 is a plate-shaped member extending substantially parallel to the rotation shaft 32 of the deburrer 10B, and the pair of floating guides 61 and the float 62 are connected to a top surface of the support plate 651. The connector plate 652 is a plate-shaped member extending upward from a rear part of the support plate 651. The mover 70 is coupled to the connector plate 652 with bolts. The support plate 651 and the connector plate 652 are arranged to form a substantially L shape in side view.

A drive mechanism 3B includes a motor 31B and a rotation shaft 32B and is connected to the cutting blades 21 and the guide roller 4 to rotate the cutting blades 21 and the guide roller 4. The motor 31B is arranged below the float support 6.

In the third embodiment, the orientation controller 80B has the float support 6, allowing the deburrer 10B to follow the shape of the surface of the joined metal members 90 at the joint 9 without using the force sensor.

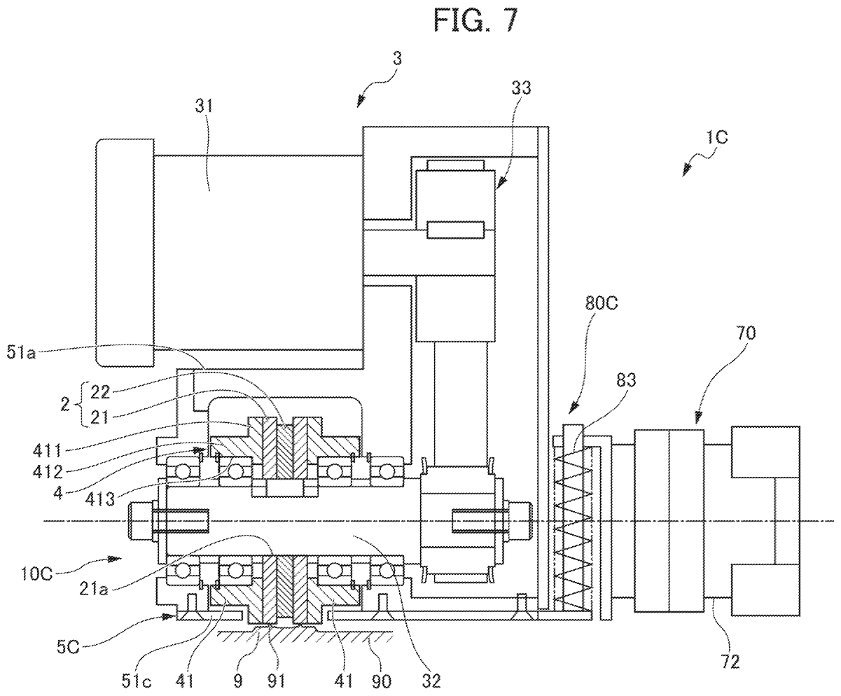

FIG. 7 is a side view of a deburring device 1C of the fourth embodiment. In the fourth embodiment, an orientation controller 80C includes a spring member 83 in place of the force sensor and the control unit. The spring member 83 is arranged between the deburrer 10C and the mover 70. The mover 70 is connected to the deburrer 10C to be coaxial with the rotation shaft 32 of the drive mechanism 3.

In the fourth embodiment, the orientation controller 80C has the spring member 83. This simple structure allows the deburrer 10C to follow the shape of the surface of the joined metal members 90 at the joint 9 without using the force sensor. The orientation controller is not limited to the force sensor or the spring, and may be any other component as long as the orientation of the deburring device can be controlled according to the shape of the surface of the joint.

The mover 70 may be connected to be coaxial with the rotation shaft 32 of the drive mechanism 3 as in the first, second, and fourth embodiments, or may be connected parallel to the rotation shaft 32 of the drive mechanism 3 as in the third embodiment.

It has been described in the embodiments that the guide roller 4 has substantially the same diameter as the cutting blades 21. However, the diameter of the guide roller 4 is not limited to be substantially the same as the cutting blades 21. The guide roller 4 may have a diameter equal to or smaller than the cutting blades 21, or a smaller diameter than the cutting blades 21. When the guide roller 4 has a smaller diameter than the cutting blades 21, the guide roller 4 does not shave, but merely touches, the metal member 90 while the cutting blades 21 shave the metal member 90. Thus, the cutting blades 21 shave the metal member 90 until the guide roller 4 touches the metal member 90, making the shaving depth greater. When the diameter of the guide roller 4 is changed as needed, how deep the cutting blades 21 shave can be controlled.

### EXPLANATION OF REFERENCE NUMERALS

1 Deburring device
3 Drive mechanism
4 Guide roller
5 Housing
9 Joint
10 Deburrer
21 Cutting blade
32 Rotation shaft
52 Opening
53 Chip suction mechanism
65 Connection
70 Mover
80 Orientation controller
81 Force sensor
82 Control unit
90 Metal member
91 Burr

What is claimed is:

1. A deburring device for removing a burr formed on a joint of metal members joined together by friction stir welding, the deburring device comprising:
a deburrer including:
a cutting blade that cuts the burr formed at the joint,
a drive mechanism that drives the cutting blade to rotate, and
a guide roller that has a diameter equal to or smaller than the cutting blade, is able to rotate coaxially with the cutting blade, and makes contact with a surface of the joined metal members at the joint to control an amount of cutting by the cutting blade;
a mover that moves the deburrer along the joint; and
an orientation controller that controls an orientation of the deburrer according to a shape of the surface of the joined metal members.

2. The deburring device according to claim 1, wherein the orientation controller includes a force sensor capable of detecting a positional change of the deburrer and
a control unit that controls the orientation of the deburrer according to a detection result of the force sensor.

3. The deburring device according to claim 2, wherein the force sensor is arranged on a connector between the deburrer and the mover and detects the positional change of the deburrer from the shape of the surface of the joined metal members at the joint, and
the control unit controls a holding position in which the mover holds the deburrer to be on the same axis as a rotation shaft of the deburrer according to the detection result of the force sensor.

4. The deburring device according to claim 2, wherein the force sensor is arranged on the guide roller and detects a positional change of the guide roller from the shape of the surface of the joined metal members at the joint, and
the control unit controls a holding position of in which the mover holds the deburrer to be on the same axis as a rotation shaft of the deburrer according to the detection result of the force sensor.

5. The deburring device according to claim 1, further comprising a housing that houses the deburrer, wherein
the housing has an opening formed at a bottom side to expose the guide roller and the cutting blade and
a chip suction mechanism that sucks air from inside the housing to suck chips of a cut burr.

6. The deburring device according to claim 2, further comprising a housing that houses the deburrer, wherein
the housing has an opening formed at a bottom side to expose the guide roller and the cutting blade and
a chip suction mechanism that sucks air from inside the housing to suck chips of a cut burr.

7. The deburring device according to claim 1, wherein the orientation controller includes a spring member that is arranged between the deburrer and the mover.

8. The deburring device according to claim 7, further comprising a housing that houses the deburrer, wherein
the housing has an opening formed at a bottom side to expose the guide roller and the cutting blade and
a chip suction mechanism that sucks air from inside the housing to suck chips of a cut burr.
